(19) United States
(12) Patent Application Publication
(10) Pub. No.: US 2002/0090538 A1
(43) Pub. Date: Jul. 11, 2002

(54) Fuel cell system and method of operating the fuel cell system

(76) Inventors: Martin Schaefer, Kirchheim/Teck (DE); Manfred Strohmaier, Ohmden (DE)

Correspondence Address: CROWELL & MORING, L.L.P., P.O. Box 14300, Washington, DC, 20044-4300, US

(21) Appl. No.: 10/022,814

(22) Filed: Dec. 20, 2001

(30) Foreign Application Priority Data
Dec. 20, 2000 (DE) 100 63 648.9

(51) Int. Cl. H01M 8/04; H01M 8/06

(52) U.S. Cl. 429/13; 429/19; 429/34; 429/20; 429/17

(57) ABSTRACT

A fuel cell system includes a fuel cell unit with an anode-side feeding and removal pipe for feeding and removing a hydrogen-containing medium to and from the fuel cell unit and a cathode-side feeding and removal pipe for feeding and removing an oxygen-containing medium to and from the fuel cell unit. The fuel cell system also includes a combustible-agent tank for storing a combustible agent from which hydrogen is obtained for supplying the fuel cell unit in a gas generating system. At least one adsorbing device is provided for adsorbing combustible-agent vapors exhaled from the combustible-agent tank. An input side of the at least one adsorbing device is connected with the combustible-agent tank and an output side of the at least one adsorbing device is connected at least temporarily with the cathode-side feeding pipe of the fuel cell unit and/or upstream of a catalytically active component in the gas generating system.

This application claims the priority of German patent document 100 63 648.9, filed Dec. 20, 2000, the disclosure of which is expressly incorporated by reference herein.

### BACKGROUND AND SUMMARY OF INVENTION

The present invention relates to a fuel cell system and to a method of operating the fuel cell system.

From German Patent Document DE 42 27 698 C2, it is known to adsorb fuel vapors exhaled from the fuel tank by activated carbon filters and to feed them to the internal-combustion engine in that the activated carbon filter is connected with an intake pipe of the internal-combustion engine and the adsorbed vapors are extracted by the vacuum existing therein. In the process, the activated carbon filter is also regenerated. The fuel quantities which are returned in this manner into the supply system of the internal-combustion engine are relatively low, so that the combustion characteristics of the internal-combustion engine are virtually not influenced.

In the case of fuel cell systems which are not operated by hydrogen gas but by combustible agents, such as methanol or the like, it is also desirable to collect easily volatile vapors of combustible agents from the combustible-agent tank by adsorbers and to prevent them from reaching the environment. It is also known to use activated carbon filters for adsorbing methanol vapors in the case of fuel cell vehicles. However, the regenerating of the adsorber in the fuel cell system presents a problem.

Thus, the adsorbed combustible agent cannot simply be added, for example, into the gas generating system in which the hydrogen for operating the fuel cell is obtained from the combustible agent. This has a disturbing effect also in low quantities because the respectively offered combustible-agent quantity, for example, during the reforming reaction and other reactions in the system, is an important operating parameter which can significantly influence the dynamics and the efficiency of the fuel cell system. A disposal in the combustible-agent tank would, in turn, mean that the tank would have to be constructed as a pressure tank. This is expensive and, mainly in the case of fuel cell vehicles, is disadvantageous for reasons of price, weight, and cost.

It is an aspect of the present invention to provide a fuel cell system in which adsorbers are used for adsorbing combustible-agent vapors and which can be regenerated in the fuel cell system.

According to the present invention, an output side of at least one adsorbing device is connected with the cathode-side feeding pipe of an oxygen-containing medium and/or upstream of a catalytically active constituent.

It is advantageous that combustible-agent vapors of the exhaled combustible agent are collected in the adsorber and are guided into the fuel cell system without interfering with the sensitive metering of the cathode-side and anode-side media.

It is particularly advantageous to use the combustible-agent vapors during the cold start of the fuel cell system in that the combustible-agent vapors are mixed with the oxygen-containing medium and are guided at least for a short time through cold-start components. Thus, the catalyst in the cold-start component can be raised to a higher temperature within a few seconds and can cause the actual catalytic conversion of the combustible agent. The cold-start phase of the fuel cell system can therefore be shortened, and fewer undesirable emissions will occur in this phase.

It is understood that the above-mentioned characteristics and the characteristics which will still be explained in the following can be used not only in the respectively indicated combination but also in other combinations or alone without leaving the scope of the present invention.

Other objects, advantages and novel features of the present invention will become apparent from the following detailed description of the present invention when considered in conjunction with the accompanying drawings.

### BRIEF DESCRIPTION OF THE DRAWINGS

FIG. 1 is a basic diagram of an arrangement of a fuel cell system according to the present invention in which combustible-agent vapors are fed to the suction pipe of a compressor and subsequently to cold-start components;

FIG. 2 is a view of another arrangement of the fuel cell system according to the present invention in which combustible-agent vapors are catalytically converted;

FIG. 3 is a view of another arrangement of the fuel cell system according to the present invention in which combustible-agent vapors are fed to a preburner/afterburner; and

FIG. 4 is a view of a detail of another arrangement of the fuel cell system according to the present invention, in which reformate is used for flushing the adsorbing device.

### DETAILED DESCRIPTION OF THE DRAWINGS

The present invention is suitable particularly for the mobile use of fuel cell systems, particularly for fuel cell vehicles.

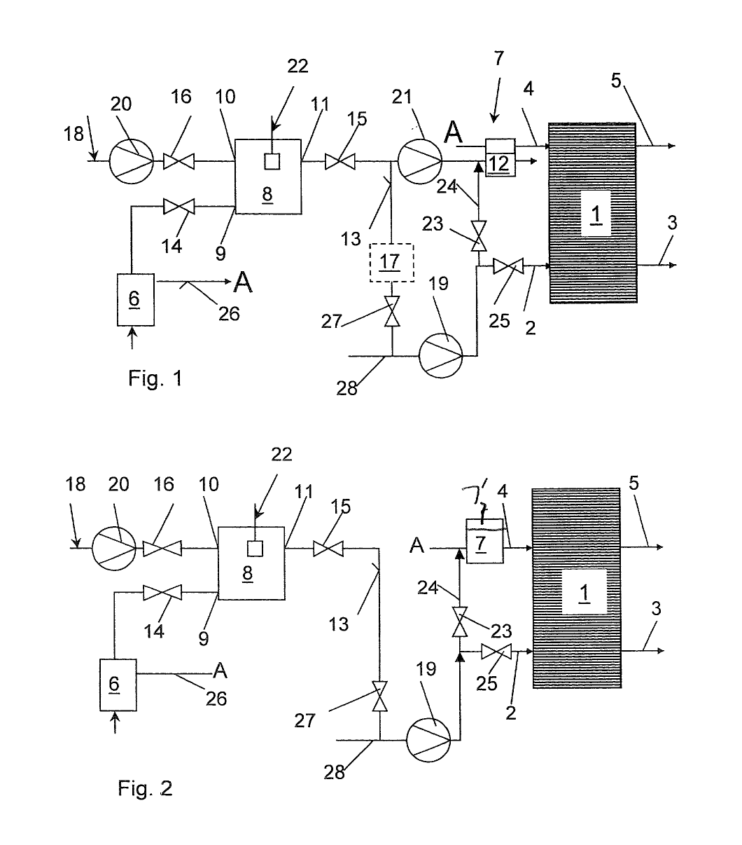

FIG. 1 illustrates a fuel cell system with a fuel cell unit 1. On the anode side, the fuel cell unit 1 has a feeding pipe 4 and a removal pipe 5 and, on the cathode side, the fuel cell unit has a feeding pipe 2 and a removal pipe 3. The fuel cell unit 1 may consist of a plurality of individual fuel cells which may be electrically connected in parallel and/or in series. By way of the feeding pipe 4, a hydrogen-containing medium, preferably hydrogen, is fed to the fuel cell unit 1 and, by way of the removal pipe 5, the anode-side exhaust gas is carried away. By way of the feeding pipe 2, an oxygen-containing medium, preferably air, is fed to the fuel cell unit 1 and, by way of the removal pipe 3 the cathode-side gas is removed. Downstream, the cathode-side and anode-side fuel cell exhaust gas can be guided together and/or can be used in a manner known per se as a heating medium in the gas generating system in order to feed heat to an evaporator, a reformer, a burner and/or a catalytic burner or to generate a catalytic conversion there of hydrogen and/or carbon monoxide in the exhaust gas.

A combustible agent, preferably methanol or another alcohol or an ether or a hydrocarbon, is stored in a combustible-agent tank 6 and is fed by way of a pipe 26 to a gas generating system. The connection between the pipe 26 and the gas generating system is indicated by the contact points A. In the gas generating system 7, preferably hydrogen is obtained from the combustible agent for supplying the fuel cell unit 1. Details of the gas generating system 7, such as the reformer, the gas purification device, the cooling system and the like, are not shown. Only a component 12 is illustrated which is to represent a directly heated component of the gas generating system 7 with one or several burners. The burner may be a burner with an open flame or a catalytic burner. Several burners may be present. One burner is preferably a preburner which heats the reformer of the gas generating system 7. In another embodiment, an afterburner may additionally be provided downstream of the reformer. The burner or burners 12 are preferably operated predominantly with fuel cell exhaust gas. The combustible-agent vapors may be added to the combustible-agent flow on the active side of the components, this alternative not being shown, or, as illustrated in the figure, on the passive side of the components.

In the fuel cell system, at least one adsorbing device 8 is provided for adsorbing combustible-agent vapors exhaled from the combustible-agent tank 6. The adsorbing device 8 expediently has a sensor 22 which indicates the loading condition of the adsorber.

An input side 9 of the at least one adsorbing device 8 is connected with the combustible-agent tank 6. An output side 11 of the at least one adsorbing device 8 may be connected with the cathode-side feeding device 2 of the oxygen-containing medium. For this purpose, a pipe 13 is provided downstream between the adsorbing device 8 and a compressor 19.

Additionally or as alternative, the output side 11 can be connected upstream with burner components 12.

For flushing the adsorber 8, a flushing pipe 18 is preferably provided which, upstream of the adsorber 8, can be closed off by a valve 16 and, downstream of the adsorber 8, can be closed off by a valve 15. Likewise, it is advantageous to arrange a valve 14 between the combustible-agent tank 6 and the adsorber 8 in order to separate the combustible-agent tank 6 and the adsorber 8 from one another. In a preferred embodiment of the present invention, the connection pipe 13 may be connected downstream of the valve 15, which connection pipe 13 is connected with the air intake pipe 28 of the compressor 19 which supplies the cathode side of the fuel cell unit 1 with an oxygen-containing medium. The compressor 19 can take in the air by way of the adsorber 8 and/or by way of the additional intake pipe 28. The intake pipe 13 can be blocked off by a valve 27. When valve 15 and valve 27 are open, the combustible-agent vapors can be sucked out of the adsorber 8 by way of the compressor 19, and the adsorber 8 can be regenerated in this manner.

Upstream of valve 16, a pump 20 may also be arranged by which the adsorbed combustible-agent vapors can be flushed out of the adsorber 8. For this purpose, valve 16 and valve 15 are opened up. Valve 14 will then expediently be closed in order not to expose the combustible-agent tank to an excessive pressure. The combustible-agent vapors are flushed out of the adsorber 8 and can preferably be fed to the burner components 12 in the gas generating system 7 and/or can be fed to the compressor 19.

Instead of the pump 20, the air from the compressor 19 or from a high-pressure compressor can be used for flushing out the adsorber 8. For this purpose, a bypass pipe, which is not shown, can be used which extends from the high-pressure side of the compressor 19 to the input 10 of the adsorber 8.

Another pump 21 may also be provided in the flushing pipe 18 downstream of the adsorber 8, which pump 21 sucks the combustible-agent vapors out of the adsorber 8.

In an alternative embodiment, it is also possible to flush the adsorber 8 by metered air flow which is provided for the oxygen supply of a carbon monoxide removal unit, which is not shown, in the gas generating system; or for supplying a heating component for a reforming reactor, such as a catalytic burner; or a reactor for the partial oxidation of carbon monoxide or an air flushing of the fuel cell unit for a so-called air bleed. For this purpose, the adsorber should be constructed to be resistant to pressure because the pressure level of this metered air is increased in comparison to normal pressure. The pressure may amount to several bar. This arrangement is advantageous because the measure intervenes at the beginning of the reaction chain in the gas generating system.

With respect to the energy, it is particularly advantageous to feed the combustible-agent vapors flushed out of the adsorber 8 to the burner components 12.

The advantage consists of the fact that the adsorber 8 can be regenerated without having to be removed from the system. Particularly when an arrangement according to the present invention is used in fuel cell vehicles, this is particularly advantageous because an onboard regeneration can be carried out.

When combustible-agent vapors are fed to the compressor 19, these can either be fed unchanged to the cathode input air or, in another advantageous further development of the present invention, can be catalytically converted and only then be admixed to the cathode input air. In the former case, the cathode input air is mixed with a small amount of combustible-agent vapors. The combustible-agent vapors are simply added to the suction pipe 28 of the compressor 19, in which case they can be sucked out of the adsorber 8 by the vacuum on the compressor suction side. For this purpose, valves 15, 16, 25, 27 are opened and valves 14, 23 are closed. Because the taken-in air quantity is very large, the combustible-agent vapors represent only a very small fraction—below 1% by volume—of the entire amount of the oxidizing medium fed to the fuel cell unit 1 on the cathode side. The fuel cell unit 1 can tolerate such an amount of combustible-agent vapors in the cathode input air.

Otherwise, an additional catalytic component 17 is provided upstream of the compressor 19 in the connection pipe 13 between the adsorbing device 8 and the compressor 19 in order to catalytically convert combustible-agent vapors which arrive in the system from the adsorber 8, and to admix the product preferably to be oxidized to the cathode input air. Although, as a result, the efficiency of the compressor 19 may be slightly reduced because the temperature of the input air is increased, this solution can be implemented in a particularly simple and easy manner. The cathode side of the fuel cell unit 1 will then not be acted upon by small amounts of combustible-agent vapors in the cathode input air.

FIG. 2 illustrates another preferred arrangement of the fuel cell system. The arrangement largely corresponds to the arrangement of FIG. 1.

The flushed-out combustible-agent vapors or the combustible-agent vapors sucked out of the adsorbing device 8 are preferably fed upstream of catalytically active components of the gas generating system 7, particularly preferably cold start components of the fuel cell system, which are used essentially in the starting phase of the fuel cell system. Cold start components preferably are those components which have a small thermal mass so that temperature changes of the components can take place rapidly. Particularly preferably, such cold start components are provided in the gas purification stage of the fuel cell system.

Particularly in the cold start case, it is advantageous to feed combustible-agent vapors to the suction side of the compressor 19 and to guide the mixture in the cold start case for igniting the catalytic reaction for a short time through catalytic regions of cold start components 7′, preferably components with catalytically active regions, in the gas generating system 7.

The addition takes place such that either the air is taken in by way of the adsorber 8 or the compressor 19 takes in fresh air by way of its additional intake pipe 28, and the combustible-agent vapors are flushed by one of the above-described measures out of the adsorber 8 and are admixed into the intake pipe of the compressor. Valve 25 is closed and valve 23 is open, so that the air/combustible-agent vapor mixture is fed by way of the pipe 24 to the corresponding cold start components 7′ of the gas generating system 7. After the ignition mixture has been guided for a defined time or until a defined temperature of cold start components has been reached through these components, the media flow can be diverted in order to flow through the cathode side of the fuel cell unit 1. For this purpose, valve 23 is closed and valve 25 is opened.

Because of the large taken-in air quantity, only very low quantities of combustible-agent vapors—no more than up to 1% by volume—are contained in the air current. However, this is sufficient for heating within a few seconds a catalyst, for example, platinum, in the cold start components to a raised temperature, for example, 200° C. In the case of the conventional cold start, among other things, the evaporator, which is supposed to evaporate the combustible agent from the combustible agent tank, will not yet be ready to operate. Thus, in the starting phase, liquid combustible agent could arrive in the cold gas generating system 7, which can be converted only with a very poor efficiency.

However, if combustible-agent vapors from the adsorber 8 are used for igniting catalytic components, particularly cold start components in the fuel cell system, preferably in the gas generating system 7, the small fraction of combustible-agent vapors in the compressor air flow already is sufficient for clearly reducing the starting time of the components. The catalytic components will now be operative to such an extent that a liquid operating medium can be converted with an improved efficiency because the evaporator and the additional components can now very rapidly reach their operating temperatures. Normally, it is sufficient to guide the mixture of compressor intake air and combustible-agent vapors for up to 5 seconds through the cold start components. This is sufficient for the ignition impulse of the catalysts. Subsequently, the media flows are guided corresponding to the normal operating conditions of the system.

The adsorber 8 is expediently selected corresponding to the used combustible agent. Preferably, an activated carbon filter is used for methanol as the combustible agent. The adsorber 8 may also be a pressure accumulator or another physically or chemically suitable storage medium.

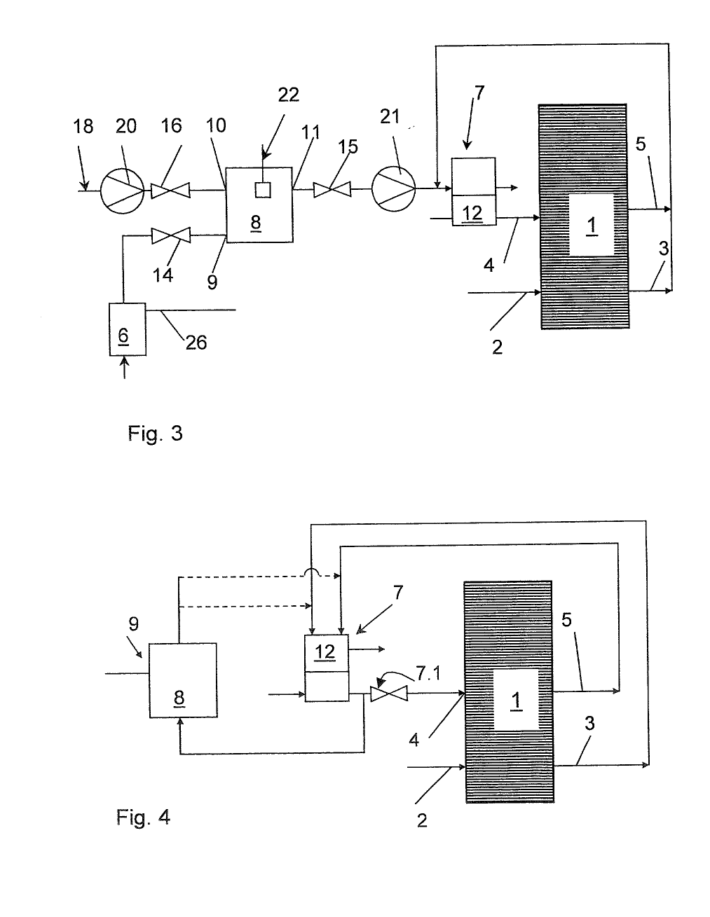

FIG. 3 illustrates a favorable further development of the fuel cell system according to the present invention. The arrangement largely corresponds again to the arrangements described in FIGS. 1 and 2. Identical elements are provided with the same reference numbers. The combustible-agent vapors from the adsorber 8 are guided into the cathode-side and/or anode-side fuel cell exhaust gas 3, 5, which is preferably guided in the gas generating system 7 to the heating side of a catalytic burner in the exhaust gas flow. This burner may be either directly heated or may be a hot-gas-heated burner in the exhaust gas flow.

FIG. 4 shows a detail of another possibility of flushing the adsorbing device 8. For reasons of clarity, only a few elements are shown. A pressure maintaining valve 7.1, which separates different pressure levels of the gas generating system 7 from the fuel cell unit 1, is assigned to the gas generating system 7. The pressure in the gas generating system 7 or the pressure in the region of the reforming of the combustible agent is higher than in the fuel cell unit 1. In the exhaust gas purification region of the fuel cell unit 1 and/or the heating region of the gas generating system 7, the pressure level is preferably lower than in the fuel cell unit 1. The pressure gradient along the flow path of the hydrogen-containing and/or oxygen-containing medium may advantageously be utilized for flushing the adsorbing device 8. In the region of high pressure, thus approximately upstream of the pressure maintaining valve 7.1, some reformate is branched off and is fed to the adsorbing device 8. The absorbing device 8 is connected on the output side preferably with the anode and/or cathode exhaust gas which is at a lower pressure than the branched-off reformate. As a result of the driving force of the pressure gradient, a pump for flushing the adsorbing device 8 can thereby be saved. The cathode and/or anode exhaust gas can be fed by way of the exhaust gas pipes 3, 5 to the exhaust gas purification 12.

The different embodiments of the present invention may also be combined with one another individually or in groups.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A fuel cell system, comprising:
a fuel cell unit with an anode-side feeding pipe and removal pipe for feeding and removing a hydrogen-containing medium to and from the fuel cell unit;
a cathode-side feeding pipe and removal pipe for feeding and removing an oxygen-containing medium to and from the fuel cell unit;
a combustible-agent tank for storing a combustible agent from which hydrogen is obtained in a gas generating system; and
at least one adsorbing device for adsorbing combustible-agent vapors exhaled from the combustible-agent tank,
wherein an input side of the at least one adsorbing device is connected with the combustible-agent tank, and
wherein an output side of the at least one adsorbing device is connected at least temporarily with at least one of the cathode-side feeding pipe and a catalytically active component in the gas generating system.

2. A fuel cell system according to claim 1, further comprising a flushing pipe for flushing the at least one adsorbing device.

3. A fuel cell system according to claim 2, further comprising at least one of a compressor, a high-pressure compressor, and a pump for supplying air for the flushing pipe.

4. A fuel cell system according to claim 1, wherein the output side of the at least on adsorbing device is connected with an air intake region of a compressor arranged in the cathode-side feeding pipe.

5. A fuel cell system according to claim 4, further comprising a catalyst for converting the combustible-agent vapors upstream of the compressor.

6. A fuel cell system according to claim 1, further comprising a pump for sucking combustible-agent vapors out of the at least one adsorbing device.

7. A fuel cell system according to claim 1, wherein the catalytically active component is at least one selected from the group consisting of:
a catalytic burner for heating a reformer in the gas generating system; a catalytic component for the oxidation of carbon monoxide;
an autothermal reforming unit; and
an afterburner in an exhaust gas flow.

8. A fuel cell system according to claim 1, wherein the at least one adsorbing device is connected on the output side with at least one of the anode removal pipe and the cathode removal pipe and is connected by a feeding pipe to a high-pressure side of a gas generating system.

9. A fuel cell system according to claim 1, wherein the at least one adsorbing device is an activated carbon filter.

10. A fuel cell system according to claim 1, wherein the at least one adsorbing device is a pressure accumulator.

11. A method of operating a fuel cell system, comprising:
adsorbing combustible-agent vapors exhaled from a combustible-agent tank with at least one adsorbing device;
at least one of feeding the adsorbed combustible-agent vapors upstream of catalytically active components of a gas generating system and mixing the adsorbed combustible-agent vapors with an oxidizing medium to a cathode side of a fuel cell unit.

12. A method according to claim 11, further comprising admixing up to 1% combustible-agent vapors to a mixture fed to the fuel cell unit on the cathode side.

13. A method according to claim 12, further comprising, during a cold start, guiding a mixture for igniting a catalytic reaction through catalytically active regions of cold start components in the fuel cell system.

14. A method according to claim 13, wherein the mixture is guided through the cold start components for up to 5 seconds.

15. A method according to claim 11, further comprising sucking the combustible-agent vapors from the at least one adsorbing device by a pump or flushing the combustible-agent vapors from the at least one adsorbing device by air from a compressor or a high-pressure compressor or a pump.

16. A method according to claim 15, further comprising feeding the combustible-agent vapors upstream of at least one of preburner and an afterburner in the gas generating system.
